(19) United States
(12) Patent Application Publication
(10) Pub. No.: US 2026/0237092 A1
(43) Pub. Date: Aug. 13, 2026

(54) METHOD FOR MANAGING THE DEPICTION OF LANDMARKS

(71) Applicant: Orange, Issy-les-Moulineaux (FR)

(72) Inventor: Ghislain Moncomble, Chatillon (FR)

(21) Appl. No.: 18/715,021

(22) PCT Filed: Nov. 23, 2022
(86) PCT No.: PCT/EP2022/082934

§ 371 Date: Aug. 14, 2025

(30) Foreign Application Priority Data
Dec. 3, 2021 (FR) 2112922

(51) Int. Cl. G06T 7/73; G06T 5/50

(52) U.S. Cl. CPC G06T 7/73; G06T 5/50; G06T 2207/20101; G06T 2207/20221; G06T 2207/30244

(57) ABSTRACT

A method is described for managing the depiction of landmarks on a screen of a device provided with a camera. The method includes calculating the pointing direction and the viewing angle of the camera of the device; determining, for a landmark located in the geographical area formed by the current pointing direction and current viewing angle of the camera of the device, a geographical coordinate of a viewpoint over the landmark; and rendering an image corresponding to a view of the landmark from the geographical coordinate.

### TECHNICAL FIELD

The technical field is that of the depiction of points of interest.

More precisely, the invention relates to a method for managing the depiction of points of interest on a screen of a device equipped with a camera.

The depiction of points of interest is important in the field of tourism in order to provide a pleasant experience for visitors to a location, for example a city having a large number of monuments that each constitute a point of interest for visitors. Points of interest may be depicted for example on a device such as a smartphone by displaying images of the points of interest under consideration on a map of the city being visited.

In addition, the use of augmented reality techniques is now well established, and this use is expanding in the tourism sector. There are many augmented reality applications that are able to be executed on devices such as smartphones or tablet computers or else on devices that completely encompass the user's vision, such as virtual reality headsets, and that allow a tourist who is visiting a city to obtain information about the points of interest of the city in question.

### Prior Art

The principle of these applications is generally as follows: the user points the camera of their smartphone or tablet at a point of interest. The user may also possess a headset virtual reality device and point their gaze at the point of interest. The augmented reality application will then recognize the point of interest in question. This recognition will be achieved through the geolocation capabilities of the smartphone or tablet or virtual reality device, as well as through its computing capabilities, by executing, on the processors of the smartphone or tablet or device, an image recognition algorithm that will compare the captured image of the point of interest with photos saved in the memory of the smartphone or tablet, or else downloaded from a remote server via a communication network. Once the point of interest has been recognized, the application will add textual or visual information about the point of interest to the image captured by the camera, and then render the image supplemented in this way on the screen of the smartphone or tablet, or else in the virtual reality image reconstructed by the device. This addition is achieved by computing a new image on the processors of the smartphone or tablet or device, this new image being formed mainly by the image captured by the camera of the smartphone or tablet or device, and by substituting this computed image for the captured image. The user will thus have available tourist information about the point of interest along with minimal location information, since they will know the point of interest at which they are pointing the camera of their smartphone or tablet.

Such augmented reality applications may be supplemented with virtual reality aspects. Rather than adding information to the real image captured by the camera of the smartphone or tablet of the user, or virtual reality device, the application will add a reconstructed image of the point of interest at the location that it occupies, or even replace the captured image completely with a reconstructed image. The image reconstructed in this way is computed in real time on the processors of the smartphone or tablet or virtual reality device depending on the orientation thereof, and then displayed on the screen of the smartphone or tablet, or else on the image reconstructed by the virtual reality device that completely encompasses the user's vision. This makes it possible for example to replace the current image of the point of interest with one or more images describing the appearance of the point of interest in various periods in the past, by computing, in real time, the image to be rendered based on models of the point of interest in various periods.

This use of virtual reality makes it possible to improve tourist interest for the augmented reality application, whether in addition to augmented reality applications or even instead thereof, if the entire image presented to the user is completely reconstructed. Indeed, virtual reality makes it possible to present users with realistic three-dimensional images, but also fun images, for example by depicting a place in various periods, or by adding fun or informative details missing from the captured image. These elements will make it possible to capture tourists' interest better and to improve their satisfaction.

However, such an augmented reality application, even when adding virtual reality capabilities thereto, remains limited to presenting the user's immediate environment. The image insertions carried out by the augmented reality application apply only to points of interest that are immediately visible to the camera of the device of the user, which will recognize the point of interest in question before inserting the images corresponding to this point of interest. The augmented reality application therefore does not allow the user to locate themselves in the city they are visiting, whereas it might be desirable for a tourist application to enable this. More generally, an augmented reality tourism application does not offer any special facility for locating oneself beyond presenting the immediate environment, regardless of the place or else the location being visited, and whether or not the application uses virtual reality in addition to augmented reality.

When points of interest are rendered outside an augmented reality or virtual reality image, this is for example done by adding an image of the points of interest under consideration on a map. This rendering makes it possible to give access to additional information and to a minimal location of the user, but it does not put the user in a situation in the same way as an augmented reality device. In particular, it does not clearly indicate the respective orientation of the user and the point of interest, since it is a flat depiction of the one or more points of interest. The invention aims to improve the situation.

### The Invention

According to a first functional aspect, the invention relates to a method for managing the depiction of points of interest on a screen of a device equipped with a camera, said method being characterized in that it comprises the following phases:
Computing a pointing direction and a viewing angle of the camera of the device;
For a point of interest located within the geographical area formed by the pointing direction and the viewing angle of the camera of the device, determining a geographical coordinate of a viewpoint on the point of interest;
Rendering, on the screen of the device, an image corresponding to a view of the point of interest from said geographical coordinate.

By virtue of the invention, the user will be able to guide themselves more easily to points of interest within an application similar to an augmented reality application. Indeed, the method will depict the image of a point of interest on the screen of the device, and do so independently of the direct visibility of the point of interest to the user, as long as the point of interest is located in the direction pointed in by the camera of the device. In particular, if the point of interest is hidden by obstacles, such as buildings or trees, the invention makes it possible to depict the point of interest on the screen of the device. It will be seen later on that the image of the point of interest rendered on the screen of the device indeed complies with the real orientation of the point of interest with respect to the pointing of the camera of the device. This compliance allows the user to locate themselves and move to the point of interest, even if this is not visible. Since the rendered image is representative of the position of the user of the device with respect to the point of interest, this allows the user to move to a specific part of the point of interest, for example the entrance door to the monument to be visited if the point of interest is a monument, and the associated image that is obtained is indeed that of the entrance door to the monument at which the camera of the device is pointing, regardless of any obstacles. The user is thus able to locate themselves without having to change application and while remaining in a tourist application that may, in some variants, use augmented reality techniques.

According to a first particular mode of implementation of the invention, which may be implemented in addition to the previous mode, with multiple geographical coordinates being associated with the point of interest, the determined geographical coordinate is chosen on the basis of the distance between the geographical coordinate of the point of interest and the device.

By virtue of this first mode of implementation, the user is able more easily to locate themselves in their environment when searching for one or more points of interest. By pointing the device in one direction, the method will select a geographical coordinate associated with the point of interest. The various geographical coordinates of a point of interest correspond for example to the various faces of the point of interest and to various viewpoints of each face. For example, by choosing, during the determination phase, the geographical coordinate of the point of interest closest to the device as the crow flies, the method ensures that the images that will be able to be obtained, which are associated with the determined geographical coordinate, will indeed be views of the point of interest from a direction close to that pointed in by the device. This determination is carried out independently of the obstacles between the device and the point of interest. As above, the point of interest is depicted even if it is not visible. Once the geographical coordinate of the point of interest has been obtained, multiple images of the point of interest may be available clearly showing a view of the point of interest from a direction close to that pointed in by the device. The obtaining phase will select between these multiple images associated with the determined geographical coordinate so as to get as close as possible to an image that is a realistic view of the point of interest from the position of the user of the device in line with the criteria of direction and viewing angle of the camera of the device. This realism makes it possible to improve the guidance of the user and for example to ensure that the user is actually targeting the face of the point of interest to which they wish to move.

According to one variant of this first mode of implementation of the invention, the rendered image corresponds to a view of the point of interest in a pointing direction and at a viewing angle that are closest to those computed.

By virtue of this variant, the realism of the obtained image is improved with regard to the obtained image complying with the orientation of the device toward the point of interest.

According to a third particular mode of implementation of the invention, which may be implemented as an alternative or in addition to the previous modes, a point of interest is determined based on a list of points of interest located within a radius around the current location of the device.

In this third embodiment, the list of points of interest the image of which is able to be rendered on the screen of the device is limited to those that are located at a predefined distance from the device and therefore from the user. There is therefore less risk of conflicts with regard to the points of interest the image of which should be rendered on the screen of the device. Only points of interest that are present at a reasonable distance will be depicted on the screen, regardless of their direct visibility in relation to the obstacles.

According to a fourth particular mode of implementation of the invention, which may be implemented as an alternative or in addition to the previous modes, a point of interest is determined based on a list of points of interest that is selected beforehand.

By virtue of this fourth particular mode of implementation of the invention, it will be for example the user who will choose the list of points of interest that is of interest to them in order to plan and personalize their visit. This mode also has the same advantage as the previous mode, namely that of not risking having to depict an excessive number of points of interest. This mode may be combined or used alternately with the previous mode of limiting points of interest within a predefined radius.

According to a fifth particular mode of implementation of the invention, which may be implemented as an alternative or in addition to the previous modes, when multiple geographical coordinates are determined within the geographical area formed by the computed pointing direction and viewing angle, multiple images corresponding respectively to views of points of interest from the geographical coordinates are rendered successively.

By virtue of this fifth particular mode of implementation of the invention, the method settles conflicts that may arise if multiple points of interest are located in the pointing direction of the camera of the device. These various points of interest should be depicted independently of the presence of obstacles between the device and the points of interest. In this embodiment, the images obtained for the various points of interest are depicted in succession one after another so that the user is made aware that multiple points of interest are located in the pointing direction of the device.

According to a sixth particular mode of implementation of the invention, which may be implemented as an alternative or in addition to the previous modes, the method is characterized in that it comprises, following the determination of a geographical coordinate of a viewpoint on the point of interest, carrying out real-time processing of an image captured by the camera of the device, wherein the image corresponding to a view of the point of interest from the determined geographical coordinate is inserted into the captured image, and the method is additionally characterized in that the processed image is rendered in real time on the screen of the device.

By virtue of this sixth embodiment, the invention assimilates an augmented reality method. Rather than presenting an image of the point of interest on the screen, as in the previous modes, the method consists in inserting the obtained image of the point of interest in real time into the real image captured by the camera of the device. In this mode, the user will see, on the screen of the device, their immediate environment as filmed by the camera, but they will additionally see, regardless of obstacles, an image of the point of interest that is located in the direction in which they are pointing the device. This addition allows them to orient themselves toward the point of interest, even if it is not directly visible, while still remaining in an augmented reality application that presents the user with their immediate environment. Multiple variants are described in conjunction with the figures, making it possible to improve the augmented reality rendering of the invention for the user.

According to a first hardware aspect, the invention relates to a device, equipped with a camera and a screen, managing the depiction of points of interest on the screen of said device, characterized in that the device comprises:
a computing module for computing the pointing direction and the viewing angle of the camera of the device;
a determination module for determining, for a point of interest located within the geographical area formed by the pointing direction and the viewing angle of the camera of the device, a geographical coordinate of a viewpoint on the point of interest;
a rendering module for rendering, on the screen of the device, an image corresponding to a view of the point of interest from said geographical coordinate.

According to another hardware aspect, the invention relates to a computer program able to be implemented by a device equipped with a camera and a screen, the program comprising code instructions that, when it is executed by a processor, carries out the steps of the management method defined above.

Finally, according to another hardware aspect, the invention relates to a data medium on which there is recorded a computer program comprising sequences of instructions for implementing the management method defined above.

The device, in addition to being equipped with a camera and a screen, has the architecture of a conventional computer. It is equipped with one or more processors capable of executing all types of computer programs, from operating systems to application software, written in compiled or interpreted languages. The various components of the device are connected to one another by a communication bus. The device may optionally be equipped with a communication system in order to communicate, via protocols such as Bluetooth, Ethernet or Wi-Fi, with other systems and to connect to mobile or non-mobile telecommunications networks. The device additionally comprises memory components that will store the data and programs needed for the device to operate.

The data media may be any entity or device capable of storing the programs. For example, the media may comprise a storage means, such as a ROM, for example a CD-ROM or a microelectronic circuit ROM, or else a magnetic recording means such as a hard disk, or more often than not a flash memory. On the other hand, the media may be transmissible media such as an electrical or optical signal, which may be routed via an electrical or optical cable, by radio or by other means. The programs according to the invention may in particular be downloaded from the Internet. As an alternative, the information medium may be an integrated circuit into which the program is incorporated, the circuit being designed to execute or to be used in the execution of the method in question.

The invention will be better understood on reading the following description, which is given by way of example and with reference to the appended drawings, in which:

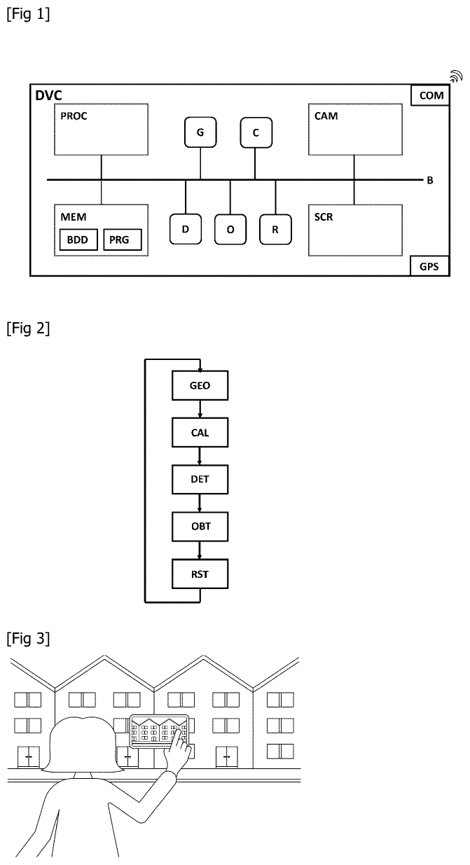

FIG. 1 shows a device equipped with a camera and a screen, which presents one possible embodiment of the invention.

FIG. 2 illustrates the phases of the method that is the subject of the invention.

FIG. 3 illustrates the situation of a user possessing the device before they trigger the method.

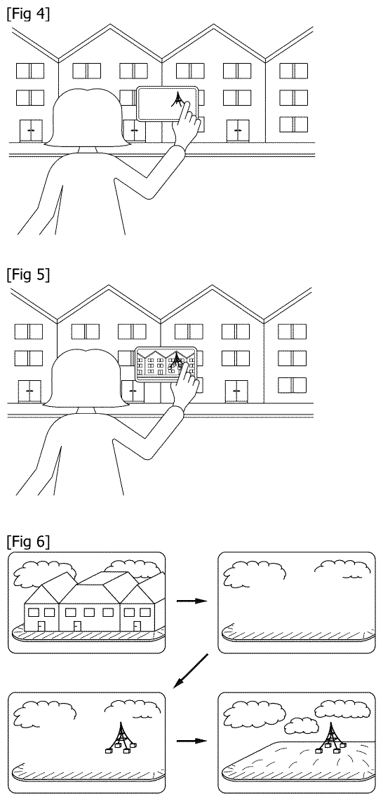

FIG. 4 illustrates the situation of the same user when they trigger the method using the device that they possess.

FIG. 5 illustrates the situation of the same user when they trigger the method using the device that they possess, according to another embodiment.

FIG. 6 illustrates the rendering, on the screen of the device, of the image processed according to one particular embodiment of the invention.

### DETAILED DESCRIPTION OF ONE OR MORE EXEMPLARY EMBODIMENTS OF THE INVENTION

FIG. 1 shows a device DVC.

The device DVC will preferably be a smartphone or a tablet computer. The description of the embodiments and figures is generally given with the assumption that the device is effectively a smartphone or a tablet computer, or other types of terminals having intermediate sizes between a smartphone or a tablet computer. However, the device DVC may also be a virtual reality device encompassing the whole of the user's vision, such as for example a headset or a glasses system. The device DVC may also be a laptop computer or even a device dedicated to the invention.

In all cases, the device DVC comprises the following hardware components.

The device DVC is equipped with a screen SCR and a camera CAM. If the device DVC is a virtual reality device, the screen SCR is the one that completely intercepts the user's vision so as to present them with a reconstructed virtual reality image, and the camera CAM is arranged so as to point in the direction of the user's gaze. The device DVC has the architecture of a conventional computer. The device DVC comprises one or more processors; a single processor PROC is shown in FIG. 1. The device DVC also comprises one or more memory components; a single memory component MEM is shown in FIG. 1. All of the hardware components of the device DVC are connected to one another by a hardware bus B. This hardware bus B serves as a support for a software bus that enables communication between the various components and modules of the device DVC.

The one or more processors PROC may be any type of microprocessor in a variety of architectures, for example and without limitation what are known as RISC (Reduced Instruction Set Computer) or CISC (Complex Instruction Set Computer) processors, or microprocessors having an ARM architecture (developed by ARM Ltd). The one or more processors PROC may perform computations for the whole device DVC or else be dedicated to managing one of the components of the device DVC, such as for example, without limitation, the screen SCR or the camera CAM.

The one or more memory components MEM may be random access memory (traditionally called RAM) components or read-only memory (traditionally called ROM) components or else flash memory components or any other type of memory.

The one or more memory components MEM are used for the data media that comprise the instructions needed for the software embedded in the device DVC to operate. FIG. 1 shows a single program PRG and a single database BDD, recorded in the memory MEM. However, it is clear that a device DVC has its processors PROC execute numerous programs PRG of all types, for example and without limitation, one or more operating systems, programs controlling the various hardware components of the device DVC, programs presenting human-machine interfaces to the user, programs executing various applications of the device DVC.

The device DVC may also preferably comprise a geolocation hardware component GPS. This component comprises chips dedicated to satellite geolocation, for example using the best known system, called GPS (Global Positioning System) , but other satellite geolocation systems may be used, such as the Galileo system, the Beidou system, or the GLONASS system (Russian acronym for Global'naya Navigatsionnaya Sputnikovaya Systema).

The device DVC may also optionally comprise one or more communication components; a single communication component COM is shown in FIG. 1. The one or more communication components COM allow the device DVC to communicate with other devices or to connect to various telecommunications networks, for example via Bluetooth, Wi-Fi or other protocols, in order to connect to other devices, or else via the GSM, 2G, 3G, 4G, 5G and other protocols in order to connect to mobile telecommunications networks. The device DVC may then be connected to the Internet.

The device DVC comprises functional modules. These modules execute phases of the method that is the subject of the invention. The various modules will comprise one or more programs PRG, and will possibly use one or more databases BDD or any other type of data saved in memory MEM to carry out their functionality.

In some embodiments, the device DVC comprises a geolocation module G. This geolocation module G is responsible, in some embodiments of the method, for executing a geolocation phase GEO of geolocating the device DVC.

For this purpose, in the vast majority of embodiments, the module G will use the satellite location component GPS. In some embodiments, the geolocation module G will rely on additional data to improve the geolocation of the device DVC. If a communication component COM is present in the device DVC, the component COM may thus provide geolocation information in accordance with the communication protocols implemented by the component COM. In the case of mobile telecommunications protocols, the component COM may have available geolocation information provided by the various antennas of the communication network with which the device DVC communicates. This geolocation information will then be used by the module G, preferably in combination with the information provided by the component GPS, to determine the precise location of the device DVC.

In another embodiment, the geolocation module G will use the images captured by the camera CAM to locate the environment of the device DVC by comparing the captured images with images recorded elsewhere, which will for example be stored in the database BDD for the purposes of other phases of the method.

The three possible sources of possible geolocation data (from the component GPS, from the component COM or from the comparison between images of the environment) may be combined with one another so as to obtain the most precise possible geolocation of the device DVC. In at least one embodiment, the geolocation module G executes the geolocation phase GEO without using data from the component GPS. In this embodiment, the component GPS is not necessarily present in the device DVC.

The device DVC comprises a computing module C. This computing module C is responsible for executing the computing phase CAL of computing the pointing direction and the viewing angle of the camera CAM of the device DVC.

In our example, this computing phase CAL relies on information from a component (not shown in the figure) of the device DVC that tracks the orientation of the device DVC. This type of information is accessible as standard in devices DVC such as smartphones or tablets, which have this kind of information available in order to orient the display of the screen SCR.

In some embodiments, the computing module C will also use the images captured by the camera CAM, possibly compared with images of the environment that may be stored in the database BDD, or else accessible via the communication component COM. In other embodiments, the computing module C may also use information from the component GPS, or else combinations of these various sources of information about the orientation of the device DVC.

The device DVC comprises a determination module D. This determination module D executes the determination phase DET of determining a point of interest located within the geographical area formed by the current pointing direction and viewing angle of the camera CAM of the device DVC as computed by the computing module C, and a geographical coordinate of said point of interest.

In order to carry out the determination phase DET of determining a point of interest, the determination module D has to access a set of map data that make it possible to ascertain the geographical coordinates of points of interest. These map data may for example be saved in a database BDD or else stored remotely and accessible through the communication component COM. On the basis of the map data and of the geolocation of the device DVC, the determination module D is able to execute the determination phase DET, which will consist in determining first a geographical area in the shape of a triangle, resulting from the location of the device DVC, centered on the pointing direction of the camera CAM of the device DVC, and with a width equal to the viewing angle of the camera CAM of the device DVC, these two variables having been computed in the computing phase CAL, and then in determining secondly whether a point of interest is located within said geographical area.

In one variant, the determination module is not contained within the device DVC, but is hosted by a server (not shown in FIG. 1) accessible to the communication component COM. In this variant, the device DVC sends, to the server, in the determination phase DET, triplets comprising the location of the device DVC and the pointing direction and the viewing angle of the camera CAM, and the determination module D returns, to the device DVC, the one or more points of interest determined as above. The advantage of this variant is that of centralizing some computations and of keeping some of them cached, for the most common from a tourist viewpoint, so as not to have to repeat them.

The determination phase DET does not take into account any obstacles to vision between the camera CAM of the device DVC and the point of interest. In our example, all of the points of interest located in the direction pointed in by the camera CAM, as long as the viewing angle permits, will be determined during the determination phase DET by the module D.

The determination phase DET should also determine a geographical coordinate of the point of interest. In some embodiments, some points of interest have only a single geographical coordinate. However, in other embodiments, the points of interest have multiple geographical coordinates. These various geographical coordinates are for example those of the various faces of the point of interest, if this is a building. As an alternative, the geographical coordinates may be for example those of the various entrance doors to the point of interest, if this is a building. A geographical coordinate associated with a point of interest may also be the coordinate of a viewpoint on the point of interest for which there is an image of the point of interest because the point of interest was photographed from the viewpoint in question.

In one embodiment, determining the geographical coordinate of the point of interest will consist in choosing the geographical coordinate on the basis of the distance separating it from the device DVC. In our example, the chosen geographical coordinate is the one that is closest to the location of the device DVC.

In this way, the geographical coordinate that is determined will be the most realistic one for the choice of the images of the point of interest associated with the geographical coordinate. If the geographical coordinate corresponds to a face of the point of interest, the images associated with this geographical coordinate will be the various views of this face of the point of interest. It is indeed this face of the point of interest that would be visible to the device regardless of the obstacles between the device and the point of interest in the chosen example where the determined geographical coordinate is the one closest to the location of the device DVC.

In one embodiment, the determination phase DET of determining the points of interest is carried out based on a list of points of interest located within a predefined radius around the device DVC. The geolocation phase GEO makes it possible to ascertain the position of the device DVC. A predefined radius, typically of a few kilometers, makes it possible to limit the number of points of interest likely to be visited. The typical distance of a few kilometers may correspond for example to a typical walk for a tourist in the environment in question.

In another embodiment, the determination phase DET of determining the points of interest is carried out based on a list of points of interest that is selected beforehand. This embodiment, which may or may not be combined with the previous embodiment, allows the user of the device DVC to select the points of interest that they wish to visit in advance, or else allows a tourist office to offer themed walks by selecting points of interest among the set of all possible points of interest, or any other choice of points of interest that is deemed relevant.

It goes without saying that the determination phase DET may determine that there are zero, one or more points of interest that are located within the geographical area formed by the current pointing direction and viewing angle of the camera CAM of the device DVC as computed by the computing module C regardless of the visibility of the point of interest in the image captured by the camera CAM, even though the presentation of the invention is described with reference to one point of interest determined in the determination phase DET, and one geographical coordinate of the point of interest, according to the various variants that have been presented.

In some embodiments, the device DVC comprises an obtaining module O. The obtaining module O, in some embodiments, will carry out an obtaining phase OBT of obtaining an image associated with said geographical coordinate of the point of interest.

The method assumes that a whole set of known photographs or else other images of the point of interest are accessible to the device, for example views drawn from multiple angles of the point of interest. These various images associated with a geographical coordinate of the point of interest may for example be saved in a database BDD, or else accessible through the communication component COM. These images may be photographs of the various views of points of interest that were taken especially for the method, or drawings of the various views of points of interest that were also created especially for the method. In other embodiments, these images will come from public or private databases to which people upload their photographs or their drawings of points of interest. In other embodiments, the method uses both images prepared especially for the method and images retrieved from public databases. These saved images are individually associated with a geographical coordinate of the point of interest. In multiple embodiments, these images are also timestamped, thereby enabling the method to obtain images of points of interest closest to the current lighting conditions. These saved images may form part of a set of geographical data that may also be used to improve the geolocation phase GEO. All of the images used by the method may be recorded in one or more databases BDD of the device, or else are located remotely and accessible through the communication component COM, or else are distributed between the two possible access modes. In some embodiments, cache mechanisms are implemented that use the one or more databases BDD of the device DVC to facilitate the obtaining phase OBT of the method. In one variant, the obtaining module O may be hosted on a server (not shown in FIG. 1) accessible to the communication component COM. This variant makes it possible to optimize the implementation of the obtaining phase OBT by distributing the load between the device DVC and the server, and to reuse photos that have already been obtained and saved in cache.

The obtaining phase OBT will consist in obtaining an image among those associated with the geographical coordinate of the point of interest determined in the determination phase DET.

In one embodiment, the obtained image will be the one that corresponds to a view of the point of interest in a pointing direction and at a viewing angle that are closest to those computed in the computing phase CAL.

In other embodiments, multiple additional criteria may be used to obtain the image of the point of interest. For example, out of multiple images of different size, the obtained image will be the one that is most representative of the expected size of the point of interest taking into account the distance between the device DVC and the point of interest, regardless of the obstacles between the device and the point of interest. In another embodiment, the obtained image is a timestamped photograph the date and time of which are closest to the current date and time, so that the lighting of the obtained image of the point of interest is as realistic as possible with respect to the lighting that would be expected if the device had a direct view of the point of interest.

The device DVC comprises a rendering module R. The rendering module R will carry out the rendering phase RST of rendering the image obtained in the obtaining phase OBT on the screen SCR of the device DVC. The rendering phase RST is a standard application of the expected functionalities of the device DVC, which will be for example a smartphone or a tablet computer.

If the device DVC is a virtual reality device, the rendering phase RST will consist in displaying the image obtained following the obtaining phase OBT on the one or more various screens SCR of the device DVC that immerse the user in virtual reality. The camera CAM of the device DVC, in the case of a virtual reality device DVC, is oriented in the direction of the user's gaze. The image rendered in the rendering phase RST by the rendering module R on the one or more screens SCR of the device DVC is the one resulting from the obtaining phase OBT. The various embodiments of the obtaining phase OBT make it possible to ensure that the obtained image is the closest one, among the images associated with the geographical coordinates of the point of interest, to the one that would correspond to the direct view for the user of the device of the point of interest regardless of the obstacles between them and the point of interest, taking into account the orientation, distance and lighting according to the various embodiments of the obtaining phase OBT.

If multiple points of interest were determined in the determination phase DET, various embodiments of the rendering phase RST make it possible to manage potential display conflicts. For example, in one embodiment, the multiple obtained images are rendered successively on the screen SCR of the device DVC. In one variant, the display order may be related to the distance between the device and the points of interest, the closest one being displayed first, and the following ones in order of distance.

In one variant, the method implements a user guidance method more immediately. In this variant, the user selects a point of interest to which they wish to move. The method will then determine whether the target point of interest is located in the pointing direction and the viewing angle of the camera CAM. If so, the method continues with the obtaining phase OBT of obtaining an image of the point of interest and the rendering phase RST of rendering it on the screen SCR as above. If the target point of interest is not located in the pointing direction, the rendering phase RST will display, on the screen SCR, an indication such as an arrow or any other graphic indicator telling the user the direction in which the camera CAM should be pointed in order to be in the direction of the selected point of interest.

FIG. 2 illustrates a succession of the phases of the method that is the subject of the invention.

The method for managing the depiction of points of interest consists of a succession of phases that follow one another in real time. It is therefore resumed in the first phase once the fifth phase is complete. The method is triggered and interrupted by actions of the user of the device DVC, such as launching or else stopping an application. These conventional points, which are well known to those skilled in the art, are not described and do not form part of the invention as such.

In some embodiments, the first phase of the method is the geolocation phase GEO. As seen above, this phase is carried out by the geolocation module G. This may rely on a component GPS comprising chips for carrying out satellite geolocation. In some variants, the geolocation phase GEO may be enhanced with data from the communication component COM and/or with a set of photographs of the environment of the user. These data may be stored in the device DVC in a database BDD, or else be accessible on a remote server (not shown) via the communication component COM. Comparing the stored or downloaded photographs with the image captured by the camera CAM of the device DVC may then improve the precision of the geolocation phase GEO.

The second phase of the method is the computing phase CAL of computing the pointing direction and the viewing angle of the camera CAM of the device DVC. This computing phase CAL relies on information from a component of the device DVC that tracks the orientation of the device DVC, accessible as standard in devices DVC such as smartphones or tablets for orienting the display of the screen SCR. In some variants, the computing phase CAL will also use the images captured by the camera CAM, possibly compared with images of the environment that may be stored in the database BDD, or else accessible via the communication component COM, or else information from the component GPS, or else combinations of these various sources of information about the orientation of the camera CAM of the device DVC.

The order of succession of the geolocation phase GEO and computing phase CAL is irrelevant.

The third phase of the method is the determination phase DET of determining a point of interest located within the triangular geographical area formed by the current pointing direction and viewing angle of the camera CAM of the device DVC as computed in the computing phase CAL, and a geographical coordinate of said point of interest. This determination is carried out independently of the visibility of the point of interest in the image captured by the camera CAM, and therefore even in the presence of obstacles that prevent the user of the device DVC from viewing the point of interest directly. The determination phase DET may determine that there are zero, one or more points of interest that are located within the geographical area formed by the current pointing direction and viewing angle of the camera CAM of the device DVC. In some embodiments, a point of interest is associated with multiple geographical coordinates, and the determination phase DET will select the geographical coordinate of the point of interest that is closest to the device DVC. In some variants, the determination phase DET will additionally be limited to points of interest contained within a predetermined radius around the device DVC and/or to points of interest contained in a predetermined list.

In some embodiments, the fourth phase of the method is the obtaining phase OBT of obtaining an image associated with said geographical coordinate of said point of interest. In some embodiments, the image obtained in the obtaining phase OBT is associated with the geographical coordinate and corresponds to a view of the point of interest in a pointing direction and at a viewing angle that are closest to those computed in the computing phase CAL. The obtaining phase OBT will select an image of a view of the point of interest among a whole set of images associated with the geographical coordinate of the point of interest determined in the determination phase DET. In some variants, these images are photographs or drawings. The images may have been created especially for the method or else may be retrieved from public databases. In some variants, the images are timestamped, and the obtaining takes into account the date and time of the image so as to select a view of the point of interest in lighting realistic for the current date and time. The images may be recorded in one or more databases BDD of the device or else be accessible through the communication component COM. In some variants, cache mechanisms are implemented. In the various variants, the obtained image is a view of the point of interest obtained regardless of the visibility of the point of interest from the device DVC, which the obtaining phase OBT chooses so as to be as realistic as possible in terms of orientation, distance or lighting.

The fifth phase of the method is the rendering phase RST of rendering the image obtained in the obtaining phase OBT on the screen SCR of the device DVC.

FIG. 3 illustrates the situation of a user possessing the device DVC before they trigger the method.

The user is seen from the back. They are looking at a cityscape, and holding the device DVC. This device is a smartphone. The camera CAM of the device DVC is activated, and the image captured by the camera CAM is rendered directly on the screen SCR of the device DVC.

FIG. 4 illustrates the situation of the same user when they trigger the method.

The successive phases GEO, CAL and DET of the method make it possible to determine that a point of interest is located in the direction pointed in by the camera CAM of the device DVC, even if the point of interest is not visible because it is hidden by buildings in the cityscape. The determination phase DET has also made it possible to determine a geographical coordinate of the point of interest that corresponds to a face of the point of interest, or else to a viewpoint on the point of interest. The geographical coordinate determined in the determination phase DET may, in one variant, be the coordinate associated with the point of interest closest to the location of the device DVC.

The obtaining phase OBT will then obtain an image that is a view of the point of interest, associated with the geographical coordinate determined in the determination phase DET. As seen above, multiple variants of the method make it possible to choose an image that is as realistic as possible in terms of orientation, distance or lighting of the point of interest with respect to the current position of the device DVC, regardless of the visibility of the point of interest from the device DVC.

The rendering phase RST will then render the image obtained in the obtaining phase OBT on the screen SCR of the device DVC. This rendered image completely replaces the image captured by the camera CAM of the device DVC. In the embodiment illustrated by FIG. 4, the method does not implement augmented reality. In this embodiment, the rendered image is the one obtained in the obtaining phase OBT, and is therefore an image unrelated to the immediate environment of the user of the device. As seen in FIG. 4, the cityscape that is the immediate environment of the user of the device DVC is no longer visible at all on the screen SCR of the device DVC following the rendering phase RST. Since the selected point of interest is the one present in the pointing direction as determined in the determination phase DET, and the image obtained in the obtaining phase OBT is as realistic as possible in terms of orientation, the user of the device DVC is able to move to the point of interest taking into account the location where they wish to arrive, even though the point of interest is not directly visible. In one variant of the method, the user may select this point of interest so as to remain in the mode of guidance to the point of interest. The obtaining phase OBT will also select the size of the rendered image so as to give an indication with regard to the distance between the user of the device DVC and the point of interest.

FIG. 5 illustrates the situation of the same user when they trigger the method, according to another embodiment.

In this embodiment, the method comprises, following the obtaining phase OBT, a real-time processing phase TRT of carrying out real-time processing of the image captured by the camera CAM of the device DVC, consisting in inserting the image obtained in the obtaining phase OBT into the captured image. In this embodiment, the rendering phase RST consists in rendering the image captured by the camera CAM of the device DVC as processed in the processing phase TRT in real time on the screen SCR of the device DVC. As a variant, additional information, such as the distance between the device DVC and the point of interest, may be displayed.

This embodiment therefore corresponds to the use of augmented reality techniques in the method.

The successive phases GEO, CAL and DET of the method make it possible to determine that a point of interest is located in the direction pointed in by the camera CAM of the device DVC, even if the point of interest is not visible because it is hidden by buildings in the cityscape. The obtaining phase OBT will then obtain an image that is a view of the point of interest, associated with the geographical coordinate determined in the determination phase DET. As seen above, multiple variants of the method make it possible to choose an image that is as realistic as possible in terms of orientation, distance or lighting of the point of interest with respect to the current position of the device DVC.

In a manner specific to the embodiment illustrated in FIG. 5, the processing phase TRT will insert the image obtained in the obtaining phase OBT in real time into the image captured by the camera CAM of the device DVC. Next, the rendering phase RST renders, in real time, the image captured by the camera CAM as processed by the processing phase TRT. The user of the device DVC thus therefore sees a point of interest that was not visible because it was hidden by the buildings in the cityscape. The inserted image is correct with regard to the orientation of the point of interest. The user of the device DVC is thereby able to move to the point of interest, taking into account the location where they wish to arrive, even though the point of interest is not directly visible.

In this embodiment, the device DVC comprises a processing module T. The processing module T will carry out the processing phase TRT of processing the image captured by the camera CAM of the device DVC in real time.

As stated above, the processing phase TRT will be applied to zero, one or more points of interest depending on those determined in the determination phase DET, according to the various variants that have been presented.

The processing phase TRT may be carried out according to multiple variants.

In a first variant, the image obtained following the obtaining phase OBT is inserted into the image captured by the camera CAM of the device DVC. Conventional image processing is necessary to extract only the view of the point of interest from the obtained image. This is typically a building, which may be easily recognized in the obtained image following the obtaining phase OBT using a conventional image processing algorithm. The processing phase TRT will then insert this significant part of the image obtained in the obtaining phase OBT into the image captured by the camera of the device DVC. This insertion will be carried out in that part of the image captured by the camera CAM where the point of interest would be located in the absence of obstacles that hide the view thereof from the user. A conventional image resizing algorithm may also be used to make the inserted image realistic in terms of the distance between the user of the device DVC and the point of interest.

In one variant, if the determination phase DET of determining points of interest determines multiple points of interest within the geographical area formed by the current pointing direction and viewing angle of the camera CAM, the processing phase TRT consists in inserting the obtained image of the point of interest closest to the device DVC in the foreground, the obtained images of other points of interest being inserted in the background. The same processing operations as seen above may be applied to the inserted images of the multiple points of interest. Potential display conflicts are thereby settled in the variant of the method that implements a processing phase TRT.

In one variant, the image representative of a point of interest that will be inserted into the image captured by the camera CAM is constructed from a set of photographs of said point of interest from numerous shooting angles. These various photographs may be obtained during the obtaining phase OBT. In this variant, the obtaining phase OBT will select multiple images corresponding to various views on the point of interest. The processing phase TRT will therefore consist, in this variant, in constructing a realistic image, in perspective, from known photographs of the point of interest that correspond to multiple views at various angles on the point of interest. These photographs, like in the previous variants, are saved in a database BDD, or else accessible through the communication component COM. These saved photographs may form part of a set of geographical data that may also be used to improve the geolocation phase GEO. In this variant, the reconstructed image of the point of interest should comply with the perspective from which the point of interest is presented to the camera CAM of the device DVC, taking into account the pointing direction and the viewing angle as computed in the computing phase CAL. As already seen, the image representative of the point of interest is inserted in the processing phase TRT, regardless of whether the point of interest is visible or else hidden by obstacles. The insertion in the processing phase TRT is carried out while complying with the real orientation of the point of interest as though it were visible to the camera CAM of the device DVC, even through any obstacles.

In one embodiment of the processing phase TRT, the image representative of the point of interest is inserted into the image captured by the camera CAM so as to have the dimensions that the point of interest would have in the captured image regardless of the visibility of the point of interest in the image captured by the camera CAM. In other words, in this variant, the method complies, in addition to the orientation of the point of interest with respect to the current pointing direction and viewing angle of the camera CAM, with the expected size of the point of interest on the basis of the distance between the device DVC and the point of interest. This compliance with the expected size of the image representative of the point of interest inserted in the processing phase TRT is generally combined with compliance with the orientation of the inserted representative image. These constraints of complying with the expected size or orientation may be applied both to an inserted representative image constructed from photographs of the point of interest taken from all angles and to a drawn image that may be inserted from all possible shooting angles. The advantage of the embodiment in which the size of the image inserted in the processing phase TRT is the expected size of the point of interest on the basis of the distance between the device DVC and the point of interest is that of facilitating user guidance. The realism of the rendering of the point of interest by the representative image inserted into the captured image is improved. In addition to complying with orientation, complying with size makes it possible to give the user information regarding their distance away from the point of interest. The user is able to be made visually aware of their distance away from the point of interest. In this case too, this information allows the user to locate themselves while still remaining in an augmented reality application that is pleasant from a tourist viewpoint.

The following phase of the method is the rendering phase RST. This phase is carried out by the rendering module R. This uses conventional functionalities of the device DVC, which presents the image captured by the camera CAM in real time on the screen SCR of the device DVC. The rendering phase RST therefore adopts this conventional device by replacing the image directly captured by the camera CAM of the device DVC with the image as produced by the processing phase TRT by the processing module T. In the variant illustrated by FIG. 5, the processing phase TRT and the rendering phase RST should therefore be carried out in real time by the processing module T and rendering module R so as not to introduce any delay between what is able to be seen by the user on the screen SCR of their device DVC and what they see directly in their environment. The method thereby adopts augmented reality techniques, by presenting to the user, on the screen SCR of the device DVC, their immediate environment as captured by the camera CAM, while adding thereto the most realistic possible image of the point of interest, even if this is not directly visible to the user because of the presence of obstacles.

FIG. 6 illustrates the rendering, on the screen SCR of the device DVC, of the image obtained according to one particular embodiment of the invention.

In this particular embodiment, the method comprises a processing phase TRT following the obtaining phase OBT, and prior to the rendering phase RST. The processing phase TRT is carried out in four steps, which are illustrated by the four images in FIG. 6. The succession of processing steps should be read from left to right and from top to bottom, as indicated by the arrows between the four images of FIG. 6.

The initial situation is the one described by the image at the top left of FIG. 6. The user of the device DVC points the camera CAM of the device DVC at a cityscape. The image of this cityscape is captured by the camera CAM of the device DVC. The determination phase DET has made it possible to determine that a point of interest is located in the pointing direction of the camera CAM computed in the phase CAL based on the location of the device DVC geolocated in the phase GEO, and that this point of interest is indeed located within a predetermined radius, or belongs to a predetermined list, according to the embodiments of the determination phase DET. However, the buildings in the cityscape form an obstacle, and the point of interest determined by the phase DET is not directly visible on the image captured by the camera CAM of the device DVC.

The obtaining phase OBT then makes it possible to obtain an image that is a view of the point of interest that is as realistic as possible in terms of orientation, distance and lighting. In some variants, multiple images may be obtained so as to construct a perspective view that is as realistic as possible. The objective is for the user of the device DVC to be able to locate themselves by seeing, on their device, a realistic depiction of the point of interest to which they move, even if this is not visible due to the presence of obstacles. It is the processing phase TRT that will process the image captured by the camera CAM of the device DVC using the information from the determination phase DET and obtaining phase OBT to construct this realistic view of the point of interest.

In this variant, the processing phase TRT will then have the following steps illustrated by FIG. 6.

The first step consists in erasing, from the image captured by the camera CAM of the device DVC, image portions corresponding to potential obstacles between the ground and the sky as filmed by the camera CAM. This erasure is carried out by a conventional image processing algorithm that will recognize portions of sky and ground in the image captured by the camera CAM and erase the rest of the captured image. This recognition algorithm may rely on geographical image data representative of the environment of the user, which data may have been saved in the database BDD or are accessible to the communication module COM and may also be used to improve the geolocation phase GEO or the computing phase CAL. The erased obstacles will first be fixed obstacles such as buildings, all types of structures, trees, all types of plants, but also moving obstacles such as passers-by, vehicles, animals.

The image obtained at the end of this first step is the one at the top right of FIG. 6.

Once the erasure has been carried out, the processing phase TRT will then consist of the step of inserting the image, which is a realistic view of the point of interest obtained in the obtaining phase OBT, into the image captured by the camera CAM. As indicated above, this insertion may have multiple variants. In all cases, the image representative of the point of interest will be oriented realistically with respect to the pointing direction and the viewing angle of the camera CAM as computed in the computing phase CAL. This realistic orientation makes it possible to ensure that the user is able to be guided appropriately using a device DVC that applies the method. In one variant, the user selects a point of interest to which they wish to be guided, the rendering phase RST will additionally display, on the screen SCR, an indication such as an arrow or any other graphic indicator telling the user the direction in which the camera CAM should be pointed in order to be in the direction of the selected point of interest.

In other variants, the representative image will additionally be realistic with regard to size by applying a computation that takes into account the size of the point of interest and the distance between the geolocation of the user determined in the phase GEO and the location of the point of interest, which may be known from the set of geographical data accessible to the method that are saved in the database BDD or accessible to the communication component COM.

In other variants, the inserted image representative of the point of interest will be constructed from photographs of said point of interest taken from numerous viewing angles. This construction is a conventional image processing algorithm that makes it possible to reconstruct a three-dimensional model of the point of interest and then to extract therefrom photographic-quality images for a given orientation and size, this orientation and this size being chosen realistically, in order to be able to appropriately guide the user of the device DVC applying the method.

The image obtained at the end of this second step is the one at the bottom left of FIG. 6.

Once the insertion has been carried out, the processing phase TRT will then consist of the step of filling in the image processed by the processing phase TRT. A first variant may consist in applying an image having a predefined texture to the portions erased in the erasure step, up to the inserted image portion representative of the point of interest.

Another variant may consist in using a conventional image processing algorithm that will first determine a horizon in the image, depending on the orientation and the viewing angle of the camera CAM of the device DVC as computed in the computing phase CAL. Textures representative of the ground and the sky are then determined based on the respective portions of ground and sky captured by the camera CAM. These textures are extended to the inserted image representative of the point of interest, while respecting the horizon determined in the image. Random effects will make it possible to decorate and embellish these fill textures.

The image obtained at the end of this third step is the one at the bottom right of FIG. 6.

To summarize, the processing phase TRT may consist, in one variant of the method, of the succession of the following steps:
Erasing, from the processed image, all potential obstacles between the user and the one or more points of interest;
Inserting, into the processed image, the one or more images representative of the one or more points of interest;
Supplementing the processed image with a predefined fill image in order to fill in the gaps left by the erasure of the obstacles up to the images representative of the one or more points of interest.

FIG. 6 shows the succession of these steps between the image captured by the camera CAM of the device DVC, which is the one at the top left of FIG. 5, and the image resulting from the processing phase TRT, which is the one at the bottom right of FIG. 6. It is this last image that will be rendered on the screen SCR of the device DVC in the rendering phase RST.

Other variants of the processing phase TRT are possible, these not being shown in a figure.

In one variant, the processing phase TRT may comprise a step consisting in adding, to the processed image, after the obstacles have been erased and the image representative of the point of interest has been inserted, an overlay of a wire-like depiction of the erased obstacles while retaining only the protruding edges of said erased obstacles. A conventional image processing algorithm is able to transform the image of the erased obstacles into this wire-like depiction. The overlay of this wire-like depiction will allow the user possessing the device DVC to retain a depiction of the obstacles that are present in order to better locate themselves in their environment, while seeing the inserted image representative of the point of interest through this wire-like depiction.

In another variant, the processing phase TRT will consist not in erasing obstacles, but in adding a transparency effect, which is conventional in image processing, to the processed image portion that corresponds to the obstacles to the view of the user and located above ground level. The insertion of the image representative of the point of interest will then give the user an effect of viewing through the obstacles, to which a transparency effect will have been applied. Like for the previous variant, the benefit of this variant is that of allowing the user to better locate themselves by retaining a depiction of the obstacles present in their immediate environment.

Other variants of the processing phase TRT are possible, consisting in applying conventional image processing algorithms to the various portions of the image captured by the camera CAM of the device DVC. These algorithms will allow differentiated processing of the various portions identified in the image captured by the camera CAM, namely in general, the ground portion, the sky portion, obstacles to the view of the user, and the one or more images representative of the point of interest inserted into the image captured by the camera CAM. The various possible steps of the processing phase TRT should, however, comply with the constraint of allowing real-time processing of the image captured by the camera CAM, in order to avoid an excessively large offset between the image rendered on the screen SCR of the device after processing and what the user is able to see in their immediate environment outside the device DVC.

It is clear that the processing phase TRT will insert zero, one or more images representative of a point of interest depending on the number of points of interest to be depicted as determined in the determination phase DET. If no point of interest is determined in the determination phase DET, the processing phase TRT may generally be omitted and the rendering phase RST will consist mainly in rendering the image captured by the camera CAM on the screen SCR of the device DVC.

As a variant, some processing operations may however be carried out even if no point of interest is determined in the phase DET as being potentially visible if the obstacles are not taken into account. For example, a decoration of the image captured by the camera CAM may be added to convey to the user that the image rendered on the screen SCR is not directly the one captured by the camera CAM and that they are using a method for depicting points of interest. Indicators may be placed on the sides of the rendered image to prompt the user to turn the camera CAM so as to orient it toward a point of interest, if it is determined that said point of interest is not present in the viewing angle of the camera CAM but is close and would be visible if the user were to reorient the device DVC.

Lastly, it should be pointed out here that, in the present text, the term “module” may correspond equally to a software component or to a hardware component or to a set of software and hardware components, a software component itself corresponding to one or more computer programs or subroutines or, more generally, to any element of a program able to implement a function or a set of functions such as described for the modules in question. In the same way, a hardware component corresponds to any element of a hardware assembly that is able to implement a function or a set of functions for the module in question (integrated circuit, chip card, memory card etc.).

1. A method for managing depiction of points of interest on a screen of a device equipped with a camera, said method comprising, for
a point of interest located within a geographical area formed by a pointing direction and a viewing angle of the camera of the device (DVC), determining a geographical coordinate of a viewpoint on the point of interest; followed by
rendering, on the screen of the device, an image corresponding to a view of the point of interest from said geographical coordinate.

2. The method of claim 1, wherein, with multiple geographical coordinates being associated with the point of interest, the determined geographical coordinate is chosen on the basis of a distance between the geographical coordinate of the point of interest and the device.

3. The method of claim 2, wherein the rendered image corresponds to a view of the point of interest in a pointing direction and at a viewing angle that are closest to the pointing direction and viewing angle of the camera of the device.

4. The method of claim 1, where a point of interest is determined based on a list of points of interest located within a predefined radius around a current location of the device (DVC).

5. The method of claim 1, wherein a point of interest is determined based on a list of points of interest that is selected beforehand.

6. The method of claim 1, wherein when multiple geographical coordinates are determined within the geographical area formed by the pointing direction and viewing angle of the camera of the device, multiple images corresponding respectively to views of points of interest from the geographical coordinates are rendered successively.

7. The method of claim 1, further comprising, following the determination of a geographical coordinate of a viewpoint on the point of interest, carrying out real-time processing of an image captured by the camera of the device, wherein the image corresponding to a view of the point of interest from the determined geographical coordinate is inserted into the captured image, wherein the processed image is rendered in real time on the screen of the device.

8. A device equipped with a camera and a screen, the device managing depiction of points of interest on the screen of said device, the device comprising:
a determination module for determining, for a point of interest located within a geographical area formed by a pointing direction and a viewing angle of the camera of the device, a geographical coordinate of a viewpoint on the point of interest; and
a rendering module for rendering, on the screen of the device, an image corresponding to a view of the point of interest from said geographical coordinate.

9. A device equipped with a camera and a screen, the device comprising a memory, the memory having stored thereon a computer program able to be implemented by the device, the program comprising code instructions that, when it is executed by a processor of the device, carries out the steps of the method of claim 1.

10. A non-transitory computer readable storage medium on which there is recorded a instructions which, when implemented by a processor, cause the processor to implement the method of claim 1.
